(19) United States
(12) Patent Application Publication
(10) Pub. No.: US 2025/0309567 A1
(43) Pub. Date: Oct. 2, 2025

(54) TERMINAL AND WIRE CONNECTION STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Nungna WI, Mie (JP)

(21) Appl. No.: 18/866,076

(22) PCT Filed: May 15, 2023
(86) PCT No.: PCT/JP2023/018156

§ 371 Date: Nov. 15, 2024

(30) Foreign Application Priority Data
May 18, 2022 (JP) 2022-081528

(51) Int. Cl. H01R 4/48

(52) U.S. Cl. CPC H01R 4/48

(57) ABSTRACT

A terminal and wire connection structure of the present disclosure includes a first wire, a second wire and a terminal for connecting the first wire and the second wire. The first wire includes a first core wire and a first insulation coating surrounding the first core wire. The second wire includes a second core wire and a second insulation coating surrounding the second core wire. The terminal includes a first connecting portion to be connected to the first core wire, a second connecting portion to be connected to the second core wire and a coupling portion coupling the first and second connecting portions.

### TECHNICAL FIELD

The present disclosure relates to a terminal-and-wire connection structure.

### BACKGROUND

A connection device described in Japanese Patent Laid-Open Publication No. 2020-187997 (Patent Document 1 below) is, for example, known as a connection structure for connecting a coated wire formed by surrounding a conductor by an insulation coating. This connection device includes a pressing member, a movable-side conductive member and a fixed-side conductive member. The pressing member is made of an electrically insulating rubber material and can be resiliently deformed.

The movable-side conductive member is, for example, formed of a plate member made of metal such as copper or aluminum, and has a shape long in a front-rear direction as a whole. The movable-side conductive member is fixed to the pressing member while being fit into an accommodation recess in the upper surface of the pressing member. The movable-side conductive member is a single component including a first contact portion, a second contact portion and a coupling portion coupling the first and second contact portions.

The fixed-side conductive member is, for example, formed of a plate member made of metal such as copper or aluminum and is a single component in which a first contact point portion, a mounting portion, a second contact point portion and a mounting portion are integrally formed side by side in this order. The fixed-side conductive member is fixed to and mounted on the ceiling surface of a connecting portion formed in a housing made of synthetic resin. On the other hand, the pressing member is arranged in a state placed on the bottom surface of the connecting portion.

The fixed-side conductive member is located above the pressing member and the movable-side conductive member and facing the movable-side conductive member across a predetermined space in a vertical direction. The first and second contact point portions project toward the movable-side conductive member. An interval in a vertical direction between the lower ends of the first and second contact point portions and the upper surface of the movable-side conductive member in a state where the pressing member is not resiliently deformed is set to be smaller than an outer diameter of the conductor.

The conductor is connected to the first contact portion and the first contact point portion by a connecting end part of the conductor entering the connecting portion and thrusting itself between the first contact portion and the first contact point portion to be sandwiched. Since the interval between the first contact portion and the first contact point portion is smaller than the outer diameter of the connecting end part in the state where the pressing member is not resiliently deformed, the connecting end part displaces the first contact portion downward and resiliently deforms the pressing member to vertically squeeze the pressing member. By a resilient restoring force of the pressing member, the conductor and the first contact portion are conductively connected at a predetermined contact pressure and the conductor and the first contact point portion are conductively connected at a predetermined contact pressure. A conductor is similarly connected to the second contact portion and the second contact point portion. In this way, a pair of the conductors are conductorly connected via the connection device.

### PRIOR ART DOCUMENT

### Patent Document

Patent Document 1: JP 2020-187997 A

### SUMMARY OF THE INVENTION

### Problems to be Solved

However, since the movable-side conductive member and the fixed-side conductive member are not constituted by one component and tolerances of the respective members need to be considered in the above connection device, it has not been easy to control a gap (interval in the vertical direction between the lower ends of the first and second contact point portions and the upper surface of the movable-side conductive member in the state where the pressing member is not resiliently deformed).

### Means to Solve the Problem

The present disclosure is directed to a terminal-and-wire connection structure with a first wire, a second wire and a terminal for connecting the first wire and the second wire, the first wire including a first core wire and a first insulation coating surrounding the first core wire, the second wire including a second core wire and a second insulation coating surrounding the second core wire, the terminal including a first connecting portion to be connected to the first core wire, a second connecting portion to be connected to the second core wire and a coupling portion coupling the first and second connecting portions, and the first connecting portion being a single component, a first receiving portion for receiving the first core wire and a first contact pressure applying portion for applying a predetermined contact pressure to the first core wire by pressing the first core wire between the first receiving portion and the first contact pressure applying portion being integrally formed in the first connecting portion.

### Effect of the Invention

According to the present disclosure, a gap can be easily controlled.

### BRIEF DESCRIPTION OF THE DRAWINGS

FIG. 1 is an exploded perspective view showing a connection structure of a terminal, a first wire and a second wire of a first embodiment.

FIG. 2 is a perspective view showing the connection structure of the terminal and the first and second wires of the first embodiment.

FIG. 3 is a section showing the connection structure of the terminal and the first wire of the first embodiment.

FIG. 4 is a perspective view showing a state where a plurality of the terminals of the first embodiment are inserted in a rubber plug in a front-rear direction.

FIG. 5 is a perspective view showing a state where the plurality of terminals of the first embodiment are inserted in the rubber plug from above while being coupled by a carrier.

FIG. 6 is an exploded perspective view showing a connection structure of a terminal, a first wire and a second wire of a second embodiment.

FIG. 7 is a perspective view showing the connection structure of the terminal and the first and second wires of the second embodiment.

FIG. 8 is a section showing the connection structure of the terminal and the first wire of the second embodiment.

### DETAILED DESCRIPTION TO EXECUTE THE INVENTION

### Description of Embodiments of Present Disclosure

First, embodiments of the present disclosure are listed and described.

(1) The terminal-and-wire connection structure of present disclosure is provided with a first wire, a second wire and a terminal for connecting the first wire and the second wire, the first wire including a first core wire and a first insulation coating surrounding the first core wire, the second wire including a second core wire and a second insulation coating surrounding the second core wire, the terminal including a first connecting portion to be connected to the first core wire, a second connecting portion to be connected to the second core wire and a coupling portion coupling the first and second connecting portions, and the first connecting portion being a single component, a first receiving portion for receiving the first core wire and a first contact pressure applying portion for applying a predetermined contact pressure to the first core wire by pressing the first core wire between the first receiving portion and the first contact pressure applying portion being integrally formed in the first connecting portion.

According to the above connection structure, since the first connecting portion is a single component in which the first receiving portion and the first contact pressure applying portion are integrally formed, a gap (dimension between the first receiving portion and the first contact pressure applying portion) can be easily controlled. Since the first core wire of the first wire receives a predetermined contact pressure by being inserted and pressed between the first receiving portion and the first contact pressure applying portion, the first core wire and the first connecting portion are conductively connected.

(2) Preferably, the first connecting portion, the coupling portion and the second connecting portion are disposed side by side in a front-rear direction, the first receiving portion is in the form of a flat plate and formed to be long in the front-rear direction, a pair of the first contact pressure applying portions are provided to rise from both left and right side edges of the first receiving portion and bilaterally symmetrically provided with respect to an axis extending in a vertical direction through a center in a lateral direction of the first receiving portion, and the first connecting portion is formed into a tube shape by the first receiving portion and the pair of first contact pressure applying portions when viewed from the front-rear direction.

Since the first connecting portion is formed into a tube shape, the gap is easily measured from the front-rear direction and can be more easily controlled.

(3) Preferably, the first receiving portion includes a bead projecting toward the first core wire and extending in the front-rear direction, and the first contact pressure applying portion includes a bead projecting toward the first core wire and extending in the front-rear direction.

Since the first receiving portion contacts the first core wire via the bead and the first contact pressure applying portion contacts the first core wire via the bead, a high contact pressure can be applied to the first core wire without providing a spring such as a resilient contact piece in the first connecting portion.

(4) Preferably, the first and second connecting portions are single components having the same shape, and the first connecting portion, the coupling portion and the second connecting portion are integrally formed.

By doing so, a gap of the second connecting portion (dimension between a second receiving portion and a second contact pressure applying portion) can be easily controlled. Since the second core wire of the second wire receives a predetermined contact pressure by being inserted and pressed between the second receiving portion and the second contact pressure applying portion, the second core wire and the second connecting portion are conductively connected. Since the first connecting portion, the coupling portion and the second connecting portion are integrally formed, the first and second wires are conductively connected via the terminal.

### Details of Embodiment of Present Disclosure

A specific example of a terminal-and-wire connection structure of the present disclosure is described with reference to the drawings. Note that the present disclosure is not limited to these illustrations, but is represented by claims and intended to include all changes in the scope of claims and in the meaning and scope of equivalents.

### First Embodiment

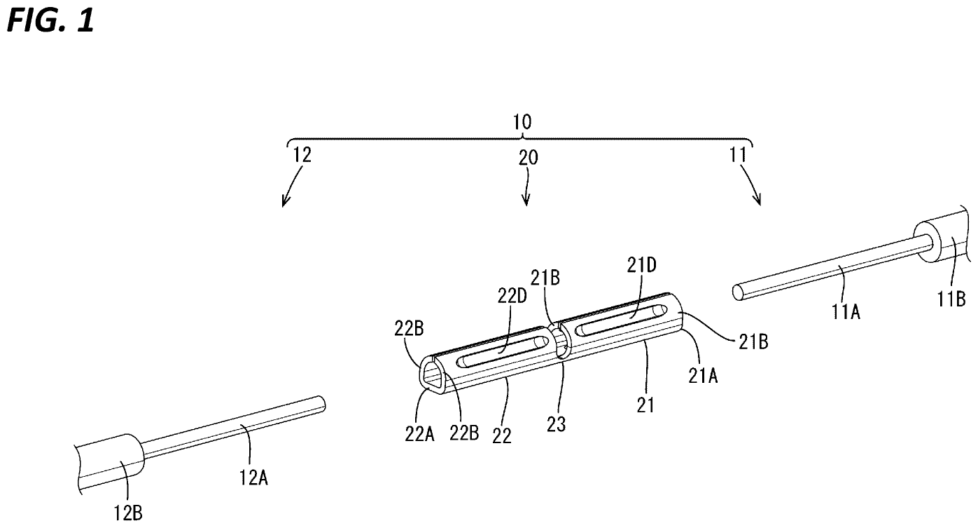

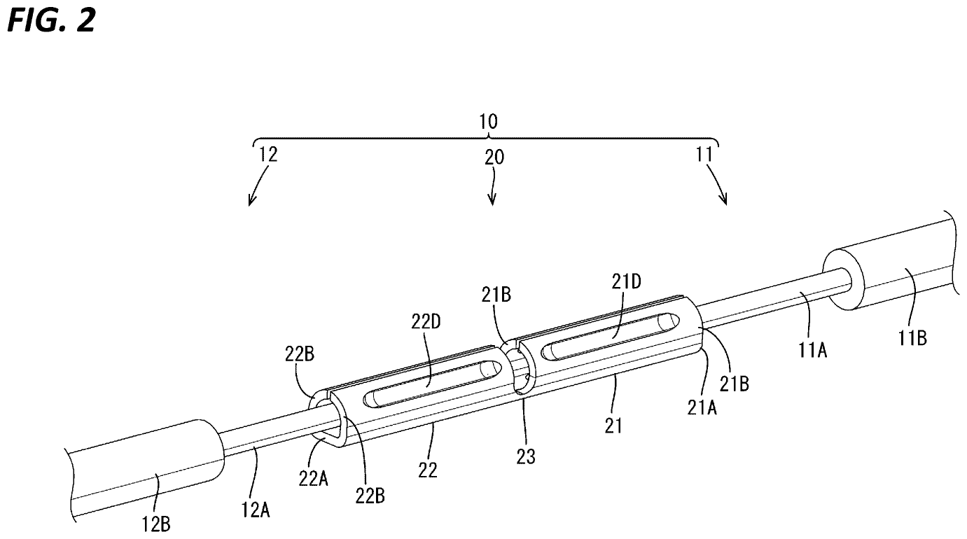

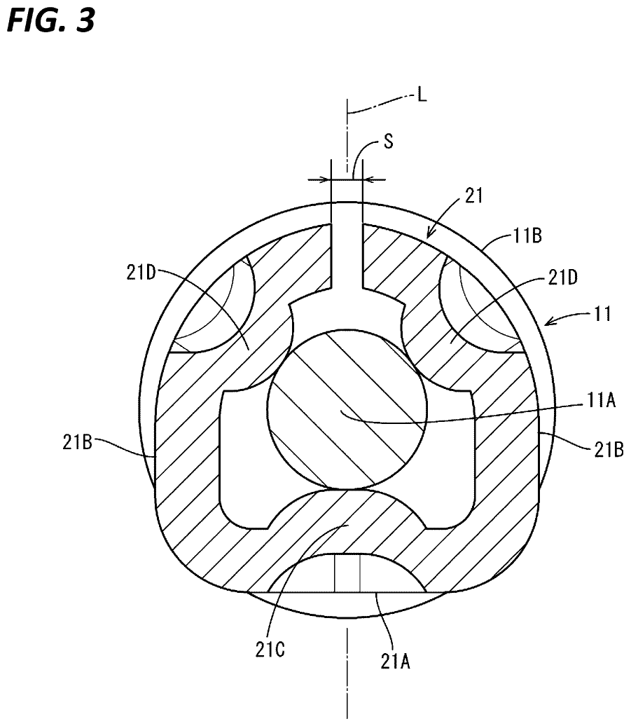

A first embodiment of the present disclosure is described with reference to FIGS. 1 to 5. In the following description, a vertical direction and a lateral direction shown in FIG. 3 are referred to as a vertical direction and a lateral direction, a longitudinal direction of a terminal 20 shown in FIGS. 1 and 2 is referred to as a front-rear direction, and insertion directions of a first wire 11 and a second wire 12 into the terminal 20 are respectively referred to as forward directions. Note that, for a plurality of identical members, only some members may be denoted by a reference sign and the other members may not be denoted by the reference sign.

The terminal-and-wire connection structure 10 of this embodiment is provided with the first wire 11, the second wire 12 and the terminal 20 as shown in FIG. 1. The first wire 11 is such a known wire that a first core wire 11A constituted by an electrically conductive single core wire or metal thin wires is surrounded by a first insulation coating 11B. Similarly, the second wire 12 is such a known wire that a second core wire 12A constituted by an electrically conductive single core wire or metal thin wires is surrounded by a second insulation coating 12B.

The terminal 20 is a female terminal made of metal and having a tubular shape. The terminal 20 is formed into a predetermined shape by a known method such as press-working, cutting or casting. An arbitrary metal such as copper, copper alloy, aluminum, aluminum alloy or stainless steel can be appropriately selected as a metal constituting the terminal 20 if necessary. A plating layer may be formed on the surface of the terminal 20. An arbitrary metal such as tin, nickel, or silver can be appropriately selected as a metal constituting the plating layer if necessary.

The terminal 20 includes a first connecting portion 21 to be connected to the first core wire 11A, a second connecting portion 22 to be connected to the second core wire 12A and a coupling portion 23 coupling the first and second connecting portions 21, 22. The first connecting portion 21, the coupling portion 23 and the second connecting portion 22 are disposed side by side in this order in the front-rear direction. The side of the coupling portion 23 when viewed from the first connecting portion 21 is referred to as a front side and the side of the coupling portion 23 when viewed from the second connecting portion 22 is referred to as a front side below.

The first and second connecting portions 21, 22 are single components having the same shape, and the first connecting portion 21, the coupling portion 23 and the second connecting portion 22 are integrally formed. Only the configuration of the first connecting portion 21 is described below, and the configuration of the second connecting portion 22 is not described. The same alphabets as the first connecting portion 21 are used in alphabet parts of reference signs for the same components as those of the first connecting portion 21.

As shown in FIG. 3, the first connecting portion 21 includes a first receiving portion 21A for receiving the first core wire 11A and a pair of first contact pressure applying portions 21B rising from both left and right side edges of the first receiving portion 21A. The first receiving portion 21A and the pair of first contact pressure applying portions 21B are integrally formed. That is, the first connecting portion 21 is a single component in which the first receiving portion 21A and the pair of first contact pressure applying portions 21B are integrally formed.

As shown in FIGS. 1 and 2, the first receiving portion 21A is in the form of a flat plate and shaped to be long in the front-rear direction. The first receiving portion 21A, the bottom wall of the coupling portion 23 and a second receiving portion 22A are formed flush with each other to constitute a flat plate. A locking structure to a housing (not shown) for accommodating the terminal 20, a rubber plug or the like may be provided on any one of the first receiving portion 21A, the bottom wall of the coupling portion 23 and the second receiving portion 22A. The pair of first contact pressure applying portions 21B are bilaterally symmetrically provided with respect to an axis L extending in the vertical direction through a center in the lateral direction of the first receiving portion 21A.

The first receiving portion 21A includes a bead 21C projecting upward and extending in the front-rear direction. The first contact pressure applying portion 21B on a left side in FIG. 3 (hereinafter, referred to as the “left first contact pressure applying portion 21B”) includes a bead 21D projecting to a right lower side and extending in the front-rear direction. Similarly, the first contact pressure applying portion 21B on a right side in FIG. 3 (hereinafter, referred to as the “right first contact pressure applying portion 21”) includes a bead 21D projecting to a left lower side and extending in the front-rear direction.

The left first contact pressure applying portion 21B is formed to arcuately extend in a clockwise direction before the bead 21D after projecting upward from the left side edge of the first receiving portion 21A. The right first contact pressure applying portion 21B is formed to arcuately extend in a counterclockwise direction before the bead 21D after projecting upward from the right side edge of the first receiving portion 21A. The first connecting portion 21 is formed into a tube shape by the first receiving portion 21A and the pair of first contact pressure applying portions 21B when viewed from the front-rear direction.

The tip of the left first contact pressure applying portion 21B and that of the right first contact pressure applying portion 21B are disposed to face each other in the lateral direction via a clearance S. The clearance S before the first core wire 11A is inserted into the first connecting portion 21 is set to be smaller than the clearance S after the first core wire 11A is inserted into the first connecting portion 21. Therefore, if the first core wire 11A is inserted into the first connecting portion 21, the pair of contact pressure applying portions 21B are resiliently expanded and deformed to be separated in the lateral direction and the clearance S becomes larger.

A predetermined contact pressure is applied to the first core wire 11A by the resilience of the pair of contact pressure applying portions 21B in an expanded and deformed state. The first receiving portion 21A presses the first core wire 11A upward via the bead 21C, the left first contact pressure applying portion 21B presses the first core wire 11A to the right lower side via the bead 21D and the right first contact pressure applying portion 21B presses the first core wire 11A to the left lower side via the bead 21D. That is, since three beads 21C, 21D are formed to project toward the first core wire 11A while being arranged to surround the first core wire 11A, the first core wire 11A receives a predetermined contact pressure from the three beads 21C, 21D.

If the first core wire 11A of the first wire 11 is inserted into the first connecting portion 21 from behind, the first core wire 11A receives the predetermined contact pressure by the bead 21C of the first receiving portion 21A and the pair of beads 21D of the pair of first contact pressure applying portions 21B, whereby the first core wire 11A and the first connecting portion 21 are conductively connected. Similarly, if the second core wire 12B of the second wire 12 is inserted into the second connecting portion 22 from behind, the second core wire 12A receives a predetermined contact pressure by a bead 22C of the second receiving portion 22A and a pair of beads 22D of a pair of second contact pressure applying portions 22B, whereby the second core wire 12A and the second connecting portion 22 are conductively connected. In this way, the first and second wires 11, 12 are conductively connected via the terminal 20.

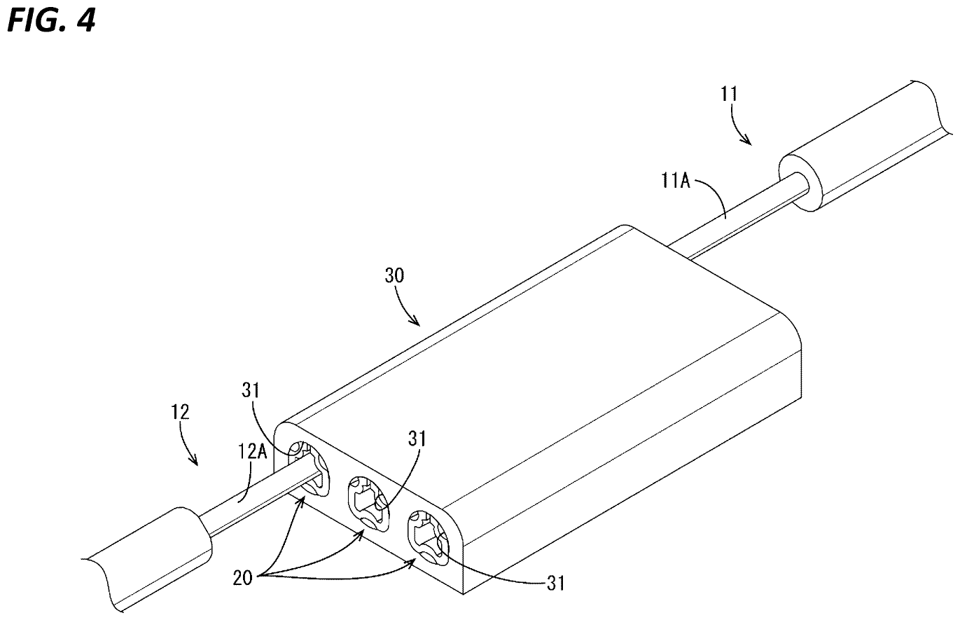

As shown in FIG. 4, the terminal 20 may be accommodated into an accommodation hole 31 of a first rubber plug 30. Since a contact pressure due to the resilience of the first rubber plug 30 is applied to the first core wire 11A in addition to the contact pressure due to the resilience of the pair of first contact pressure applying portions 21B, a high contact pressure can be applied to the first core wire 11A.

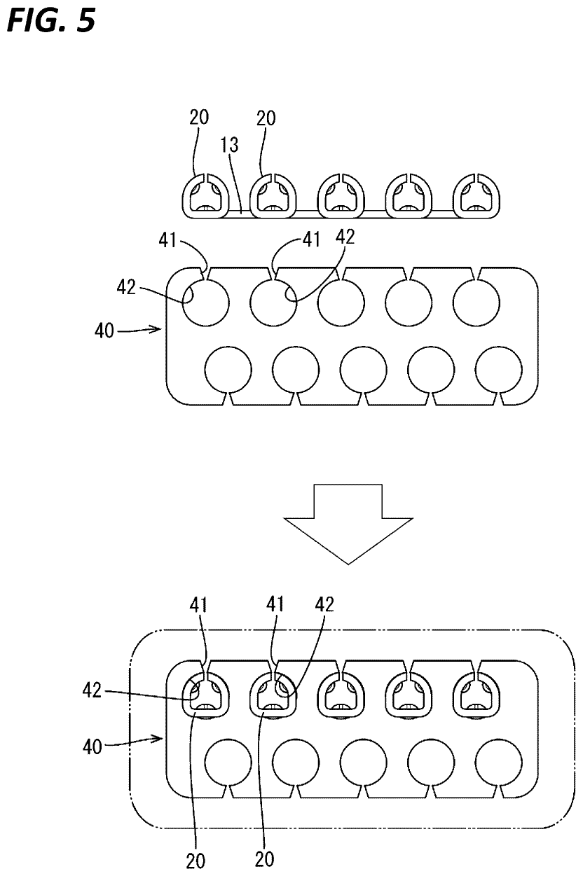

In the case of FIG. 4, there is a possibility that the first rubber plug 30 is damaged by corner parts of the terminal 20 and broken pieces of the first rubber plug 30 enter the terminal 20 when the terminal 20 is inserted into the accommodation hole 31 of the first rubber plug 30. As a countermeasure against this, it is thought to use a second rubber plug 40 formed with cuts 41 as shown in FIG. 5. The second rubber plug 40 includes a plurality of accommodation holes 42 arranged in the lateral direction in two upper and lower stages. The cuts 41 are formed in an upper part of the second rubber plug 40 in the accommodation holes 42 in the upper stage, and the cuts 41 are formed in a lower part of the second rubber plug 40 in the accommodation holes 42 in the lower stage. The plurality of terminals 20 are chain terminals coupled by a carrier 13. If the respective terminals 20 are collectively inserted into the second rubber plug 40 from above, the respective terminals 20 are accommodated into the respective accommodation holes 42 while pushing and widening the respective cuts 41. By doing so, the second rubber plug 40 is not damaged by corner parts of the terminals 20.

### Functions and Effects of First Embodiment

The terminal-and-wire connection structure 10 of the present disclosure is provided with the first wire 11, the second wire 12 and the terminal 20 for connecting the first and second wires 11, 12, the first wire 11 includes the first core wire 11A and the first insulation coating 11B surrounding the first core wire 11A, the second wire 12 includes the second core wire 12A and the second insulation coating 12B surrounding the second core wire 12A, the terminal 20 includes the first connecting portion 21 to be connected to the first core wire 11A, the second connecting portion 22 to be connected to the second core wire 12A and the coupling portion 23 coupling the first and second connecting portions 21, 22, and the first connecting portion 21 is a single component in which the first receiving portion 21A for receiving the first core wire 11A and the first contact pressure applying portions 21B for applying a predetermined contact pressure to the first core wire 11A by pressing the first core wire A between the first receiving portion 21A and the first contact pressure applying portions 21B are integrally formed.

According to the above connection structure 10, since the first connecting portion 21 is a single component in which the first receiving portion 21A and the first contact pressure applying portions 21B constituting the first connecting portion 21 are integrally formed, a gap (dimension between the first receiving portion 21A and the first contact pressure applying portions 21B) can be easily controlled. Since the first core wire 11A of the first wire 11 receives a predetermined contact pressure by being inserted and pressed between the first receiving portion 21A and the first contact pressure applying portions 21B, the first core wire 11A and the first connecting portion 21 are conductively connected.

Preferably, the first connecting portion 21, the coupling portion 23 and the second connecting portion 22 are disposed side by side in the front-rear direction, the first receiving portion 21A is in the form of a flat plate and formed to be long in the front-rear direction, the pair of first contact pressure applying portions 21B are provided to rise from the both left and right side edges of the first receiving portion 21A, the pair of first contact pressure applying portions 21B are bilaterally symmetrically provided with respect to the axis L extending in the vertical direction through the center in the lateral direction of the first receiving portion 21A, and the first connecting portion 21 is formed into a tube shape by the first receiving portion 21A and the pair of first contact pressure applying portions 21B when viewed from the front-rear direction.

Since the first connecting portion 21 is formed into a tube shape, the gap is easily measured from the front-rear direction and the gap can be more easily controlled.

Preferably, the first receiving portion 21A includes the bead 21C projecting toward the first core wire 11A and extending in the front-rear direction, and the first contact pressure applying portion 21B includes the bead 21D projecting toward the first core wire 11A and extending in the front-rear direction.

Since the first receiving portion 21A contacts the first core wire 11A via the bead 21C and the first contact pressure applying portions 21B contact the first core wire 11A via the beads 21D, a high contact pressure can be applied to the first core wire 11A without providing a spring such as a resilient contact piece in the first connecting portion 21.

Preferably, the first and second connecting portions 21, 22 are single components having the same shape, and the first connecting portion 21, the coupling portion 23 and the second connecting portion 22 are integrally formed.

By doing so, a gap of the second connecting portion 22 (dimension between the second receiving portion 22A and the second contact pressure applying portions 22B) can be also easily controlled. Since the second core wire 12A of the second wire 12 receives a predetermined contact pressure by being inserted and pressed between the second receiving portion 22A and the second contact pressure applying portions 22B, the second wire 12A and the second connecting portion 22 are conductively connected. Since the first connecting portion 21, the coupling portion 23 and the second connecting portion 22 are integrally formed, the first and second wires 11, 12 are conductively connected via the terminal 20.

### Second Embodiment

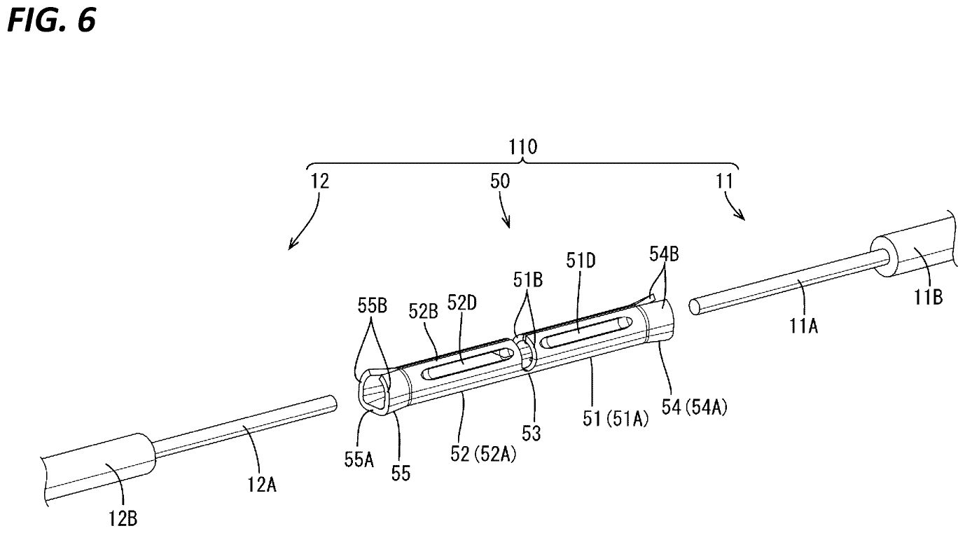

A second embodiment of the present disclosure is described with reference to FIGS. 6 to 8. A terminal-and-wire connection structure 110 of the second embodiment is obtained by adding a guiding shape to the terminal 20 of the first embodiment. In the configuration of a terminal 50 of the second embodiment, the same components as those of the terminal 20 of the first embodiment are denoted by reference signs whose number in tens place is changed from 2 to 5 and the description thereof may be omitted.

The terminal 50 includes a first connecting portion 51, a second connecting portion 52, a coupling portion 53, a first guide portion 54 extending rearward from the rear end of the first connecting portion 51 and a second guide portion 55 extending rearward from the rear end of the second connecting portion 52. The first and second guide portions 54, 55 have a guiding shape formed to be wider toward a rear side. Since the first and second guide portions 54, 55 have the same shape, the first guide portion 54 is representatively described below and the same components as those of the first guide portion 54 are denoted by reference signs whose number in ones place is changed from 4 to 5.

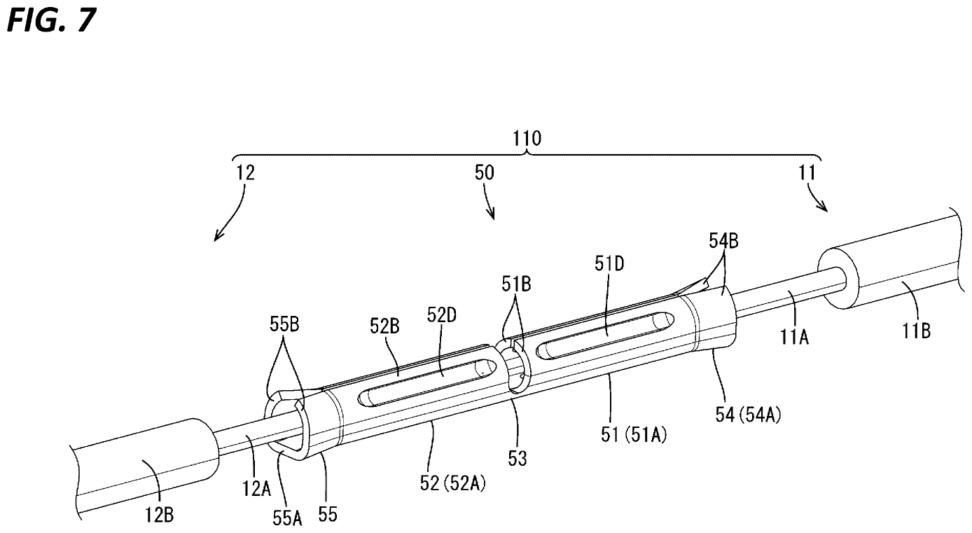

As shown in FIGS. 6 and 7, the first guide portion 54 is connected to the rear end of the first connecting portion 51 and integrally formed to the first connecting portion 51. The first guide portion 54 is a single component in which a first bottom wall 54A and a pair of first side walls 54B rising upward from both side edges of the first bottom wall 54A are integrally formed.

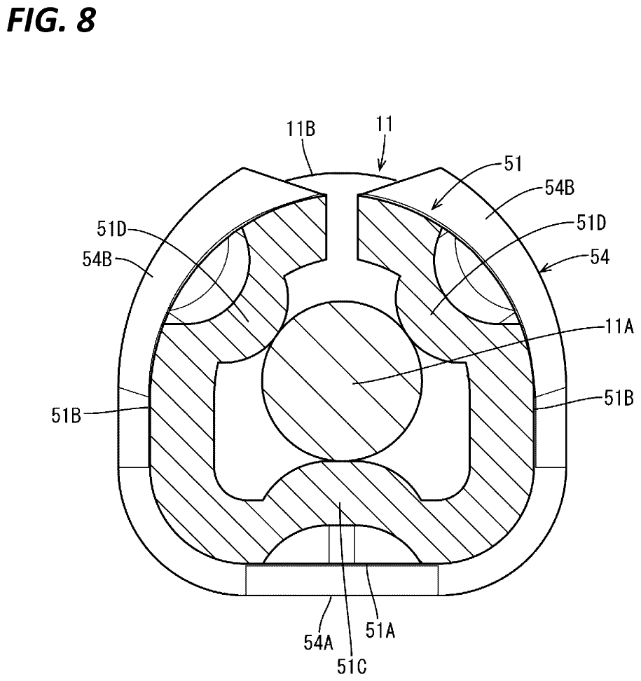

The first bottom wall 54A is in the form of a flat plate and connected to the rear end of a first receiving portion 51A. As shown in FIG. 8, the first bottom wall 54A is formed to extend downward and have a larger dimension in the lateral direction toward a rear side.

The left first side wall 54B is connected to the rear end of a left first contact pressure applying portion 51B. The left first side wall 54B is formed to arcuately extend in a clockwise direction before a position corresponding to a bead 51D when viewed from the front-rear direction after projecting upward from the left side edge of the first bottom wall 54A.

The right first side wall 54B is connected to the rear end of a right first contact pressure applying portion 51B. The right first side wall 54B is formed to arcuately extend in a counterclockwise direction before a position corresponding to a bead 51D when viewed from the front-rear direction after projecting upward from the right side edge of the first bottom wall 54A.

The pair of first side walls 54B are so formed that a height from the first bottom wall 54A increases and a separation distance in the lateral direction increases toward the rear side.

If a first core wire 11A of a first wire 11 is inserted into the first connecting portion 51 from behind, the first core wire 11A is guided by the first guide portion 54, enters the first connecting portion 51 and receives a predetermined contact pressure by a bead 51C of the first receiving portion 51A and the pair of beads 51D of the pair of first contact pressure applying portions 51B, whereby the first core wire 11A and the first connecting portion 51 are conductively connected. Similarly, if a second core wire 12B of a second wire 12 is inserted into the second connecting portion 52 from behind, the second core wire 12A is guided by the second guide portion 55, enters the second connecting portion 52 and receives a predetermined contact pressure by a bead 52C of the second receiving portion 52A and a pair of beads 52D of a pair of second contact pressure applying portions 52B, whereby the second core wire 12A and the second connecting portion 52 are conductively connected. In this way, the first and second wires 11, 12 are conductively connected via the terminal 50.

### Other Embodiments

(1) Although the first connecting portion including the pair of contact pressure applying portions have been illustrated in the above first and second embodiments, the number of the contact pressure applying portion(s) of the first connecting portion may be one, three or more.

(2) Although the pair of first contact pressure applying portions have been illustrated to be bilaterally symmetrically formed with respect to the axis L in the above first and second embodiments, the pair of first contact pressure applying portions need not be bilaterally symmetrical and may be so asymmetrically formed with respect to the axis L that the entire first connecting portion has a tube shape.

(3) Although the first connecting portion including the beads has been illustrated in the above first and second embodiments, a spring such as a resilient contact piece may be provided instead of the beads in the first connecting portion.

(4) Although the contact pressure has been increased by the rubber plug separate from the terminal 20 in the above first embodiment, the contact pressure may be increased by a separate SUS spring.

### LIST OF REFERENCE NUMERALS

10: terminal-and-wire connection structure, 11: first wire, 11A: first core wire, 11B: first insulation coating, 12: second wire, 12A: second core wire, 12B: second insulation coating, 13: carrier
20: terminal, 21: first connecting portion, 21A: first receiving portion, 21B: first contact pressure applying portion, 21C: bead, 21D: bead, 22: second connecting portion, 22A: second receiving portion, 22B: second contact pressure applying portion, 22C: bead, 22D: bed, 23: coupling portion
30: first rubber plug, 31: accommodation hole
40: second rubber plug, 41: cut, 42: accommodation hole
50: terminal, 51: first connecting portion, 51A: first receiving portion, 51B: first contact pressure applying portion, 51C: bead, 51D: bead, 52: second connecting portion, 52A: second receiving portion, 52B: second contact pressure applying portion, 52C: bead, 52D: bead, 53: coupling portion, 54: first guide portion, 54A: first bottom wall, 54B: first side wall, 55: second guide portion, 55A: second bottom wall, 55B: second side wall
110: terminal-and-wire connection structure
L: axis, S: gap

1. A terminal and wire connection structure, comprising a first wire, a second wire and a terminal for connecting the first wire and the second wire,
the first wire including a first core wire constituted by a single core wire and a first insulation coating surrounding the first core wire,
the second wire including a second core wire constituted by a single core wire and a second insulation coating surrounding the second core wire,
the terminal including a first connecting portion to be connected to the first core wire, a second connecting portion to be connected to the second core wire and a coupling portion coupling the first and second connecting portions,
the first connecting portion being a single component, a first receiving portion for receiving the first core wire and a first contact pressure applying portion for applying a predetermined contact pressure to the first core wire by pressing the first core wire between the first receiving portion and the first contact pressure applying portion being integrally formed in the first connecting portion, and
the terminal being accommodated in an accommodation hole of a rubber plug, a contact pressure due to resilience of the rubber plug being applied to the first core wire in addition to the contact pressure by resilience of the first contact pressure applying portion.

2. The terminal and wire connection structure of claim 1, wherein:
the first connecting portion, the coupling portion and the second connecting portion are disposed side by side in a front-rear direction,
the first receiving portion is in the form of a flat plate and formed to be long in the front-rear direction,
a pair of the first contact pressure applying portions are provided to rise from both left and right side edges of the first receiving portion and bilaterally symmetrically provided with respect to an axis extending in a vertical direction through a center in a lateral direction of the first receiving portion, and
the first connecting portion is formed into a tube shape by the first receiving portion and the pair of first contact pressure applying portions when viewed from the front-rear direction.

3. The terminal and wire connection structure of claim 2, wherein:
the first receiving portion includes a bead projecting toward the first core wire and extending in the front-rear direction, and
the first contact pressure applying portion includes a bead projecting toward the first core wire and extending in the front-rear direction.

4. The terminal and wire connection structure of claim 1, wherein:
the first and second connecting portions are single components having the same shape, and
the first connecting portion, the coupling portion and the second connecting portion are integrally formed.
